(19) United States
(12) Patent Application Publication
(10) Pub. No.: US 2010/0023752 A1
(43) Pub. Date: Jan. 28, 2010

(54) METHOD AND DEVICE FOR TRANSMITTING GROUPCAST DATA IN A WIRELESS MESH COMMUNICATION NETWORK

(75) Inventors: Charles R. Barker, Orlando, FL (US); Michael F. Korus, Eden Prairie, MN (US); Ohad Shatil, Kenosha, WI (US); Heyun Zheng, Sichuan (CN)

Correspondence Address: MOTOROLA, INC, 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/965,430

(22) Filed: Dec. 27, 2007

(51) Int. Cl. H04L 9/32; H04H 20/71; H04L 29/06; H04L 9/08

(52) U.S. Cl. 713/153; 370/312; 370/400; 713/168; 380/281

(57) ABSTRACT

A method for transmitting groupcast data in a wireless mesh communication network as provided improves security of groupcast data. The method comprises processing, at a supplicant node, authentication handshake data received from an authenticator node, wherein the supplicant node is a next-hop neighbor of the authenticator node away from a root node. The supplicant node then stores a group transient key (GTK) received from the authenticator node. Next, the supplicant node processes authentication handshake data received from a third node, wherein the third node is a next-hop neighbor of the supplicant node away from the root node. The GTK is then transmitted from the supplicant node to the third node. Encrypted groupcast data are then generated at the supplicant node by using the GTK to encrypt groupcast data received from the authenticator node. Finally, the encrypted groupcast data are transmitted from the supplicant node to the third node.

### FIELD OF THE INVENTION

The present invention relates generally to wireless communication networks, and in particular to providing secure communication of groupcast data in a wireless mesh communication network.

### BACKGROUND

Many wireless communication systems require a rapid deployment of independent mobile users as well as reliable communications between user nodes. Mesh networks, such as Mobile Ad Hoc Networks (MANETs), are based on self-configuring autonomous collections of portable devices that communicate with each other over wireless links having limited bandwidths. A mesh network is a collection of wireless nodes or devices organized in a decentralized manner to provide range extension by allowing nodes to be reached across multiple hops. In a mesh network, communication packets sent by a source node thus can be relayed through one or more intermediary nodes before reaching a destination node. Mesh networks may be deployed as temporary packet radio networks that do not involve significant, if any, supporting infrastructure. Rather than employing fixed base stations, in some mesh networks each user node can operate as a router for other user nodes, thus enabling expanded network coverage that can be set up quickly, at low cost, and which is highly fault tolerant. In some mesh networks, special wireless routers also may be used as intermediary infrastructure nodes. Large networks thus can be realized using intelligent access points (IAPs), also known as gateways or portals, which provide wireless nodes with access to a wired backhaul or wide area network (WAN).

Mesh networks can provide critical communication services in various environments involving, for example, emergency services supporting police and fire personnel, military applications, industrial facilities and construction sites. Mesh networks are also used to provide communication services in homes, in areas with little or no basic telecommunications or broadband infrastructure, and in areas with demand for high speed services (e.g., universities, corporate campuses, and dense urban areas).

However, establishing secure communications between nodes in a mesh communication network can be complex. Conventional mobile devices such as cellular phones often obtain communication security using infrastructure-based authentication processes. Devices are generally authenticated through an Access Point (AP), such as a base station, which is connected to an authentication server. An authentication request can be transmitted for example using an Extensible Authentication Protocol (EAP) comprising EAP Over Local Area Network (EAPOL) packets. The authentication process involves several EAPOL packets being transmitted and received, beginning with an EAP Start packet and finishing with either an EAP Success message packet or an EAP Failure message packet. The authentication server stores the authentication credentials of a mobile device (typically called a supplicant) that is being authenticated. Authentication servers also can be connected to other authentication servers to obtain supplicant authentication credentials that are not stored locally.

In infrastructure-based mobile networks, a centralized procedure is often followed where a single AP handles an authentication process for all supplicants within range of the AP. For example, prior systems which adhere to American National Standards Institute/Institute of Electrical and Electronics Engineers (ANSI/IEEE) 802.1X or ANSI/IEEE 802.11i standards utilize such a centralized procedure. However, because every supplicant can be authenticated only via an AP, such a centralized procedure is not practical in wireless mesh communication networks, which often have nodes operating outside of the wireless range of an Intelligent AP (IAP). An IAP is an access point providing WAN connectivity to wireless network nodes that may be one or more hops away from the IAP. Wireless mesh communication networks thus often involve complex mutual authentication methods performed between all neighboring network nodes, which can consume significant time and processor resources of the network nodes.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a schematic diagram illustrating a use of a plurality of group transient keys (GTKs) in a wireless mesh communication network, according to the prior art.

FIG. 2 is a schematic diagram illustrating a use of a single GTK in a wireless mesh communication network, according to some embodiments of the present invention.

FIG. 3 is a schematic diagram illustrating a use of two GTKs in a wireless mesh communication network, according to some embodiments of the present invention.

FIG. 4 is a schematic diagram illustrating a modification of the wireless mesh communication network shown in FIG. 3, according to some embodiments of the present invention.

FIG. 5 is a general flow diagram illustrating a method for transmitting groupcast data in a wireless mesh communication network, according to some embodiments of the present invention.

FIG. 6 is a block diagram illustrating system components of the node D of the wireless mesh communication network shown in FIG. 3, according to some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to transmitting groupcast data in a wireless mesh communication network. Accordingly, the apparatus components and method steps have been represented where appropriate by conventional symbols in the drawings, showing only those specific details that are pertinent to understanding the embodiments of the present invention, so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of transmitting groupcast data in a wireless mesh communication network as described herein. The non-processor circuits may include, but are not limited to, a radio receiver, a radio transmitter, signal drivers, clock circuits, power source circuits, and user input devices. As such, these functions may be interpreted as steps of a method for transmitting groupcast data in a wireless mesh communication network. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Any embodiment described herein is not necessarily to be construed as preferred or advantageous over other embodiments. All of the embodiments described in this Detailed Description are illustratively provided to enable persons skilled in the art to make or use the invention and not to limit the scope of the invention which is defined by the claims.

According to one aspect, some embodiments of the present invention define a method for transmitting groupcast data in a wireless mesh communication network. The method comprises processing, at a supplicant node, authentication handshake data received from an authenticator node, wherein the supplicant node is a next-hop neighbor of the authenticator node away from a root node. The supplicant node then stores a group transient key received from the authenticator node. Next, the supplicant node processes authentication handshake data received from a third node, wherein the third node is a next-hop neighbor of the supplicant node away from the root node. The group transient key is then transmitted from the supplicant node to the third node in response to processing the authentication handshake data received from the third node. Encrypted groupcast data are then generated at the supplicant node by using the group transient key to encrypt groupcast data received from the authenticator node. Finally, the encrypted groupcast data are transmitted from the supplicant node to the third node.

Some embodiments of the present invention thus enable an effective synchronization of groupcast keys at all network nodes that use a same groupcast root node. That enables group traffic to flow between network nodes with a single key, thereby eliminating packet duplication, multiple keys, and complex key management. Also, group traffic can be allowed to flow between network nodes where a secure link had not previously been established between the nodes. The method further provides groupcast path redundancy, which improves a reliability of group traffic and thus improves overall network quality of service (QoS).

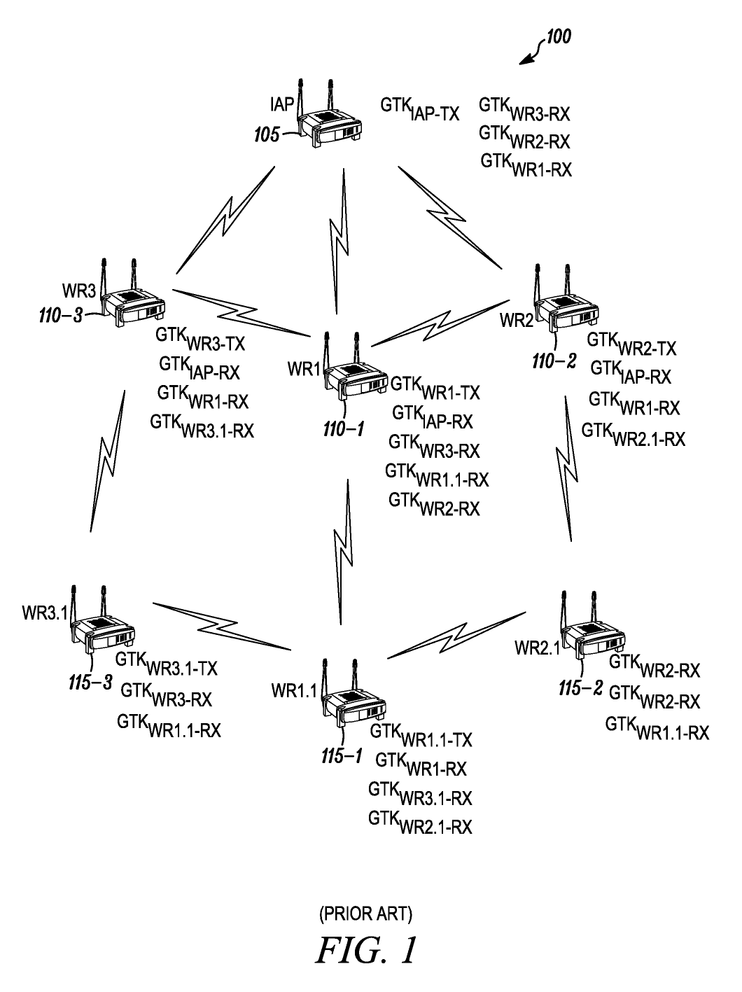

Referring to FIG. 1, a schematic diagram illustrates a use of a plurality of group transient keys (GTKs) in a wireless mesh communication network 100, according to the prior art. The GTKs can be used to encrypt, decrypt, authenticate and validate groupcast data after an authentication process is completed with neighboring network nodes. The wireless mesh communication network 100 includes an intelligent access point (IAP) 105 that is in direct wireless communication with a first set of wireless nodes 110-n (i.e., wireless nodes 110-1, 110-2, and 110-3). The first set of wireless nodes 110-n are then in direct wireless communication with a second set of wireless nodes 115-n (i.e., wireless nodes 115-1, 115-2, and 115-3). To securely transmit groupcast data (i.e., data that are broadcast or multicast in the wireless mesh communication network 100), the IAP 105 and each wireless node 110-n, 115-n must maintain a plurality of group transient keys that are exchanged during security authentication sessions between the IAP 105, the wireless nodes 110-n, and the wireless nodes 115-n. For example, such GTKs can be exchanged in accordance with the Institute of Electrical and Electronics Engineers (IEEE) 802.11i standard. (IEEE standards or specifications referred to herein may be obtained at http://standards.ieee.org/getieee802/index.html or by contacting the IEEE at IEEE, 445 Hoes Lane, PO Box 1331, Piscataway, N.J. 08855-1331, USA.)

However, according to standards such as the IEEE 802.11i standard, GTKs are unidirectional keys only. Thus a supplicant node, such as the wireless node 110-2, cannot transmit using a GTK provided by its authenticator node, such as the IAP 105. Rather, the supplicant node can use such a GTK only for decryption of packets received from the authenticator node. Thus to enable groupcast data to flow in either direction between the IAP 105 and the wireless node 110-2, two GTK's must be exchanged between the IAP 105 and the wireless node 110-2: one GTK for transmitting data, and one GTK for receiving data. Similarly, the first set of wireless nodes 110-n and the second set of wireless nodes 115-n must also exchange multiple GTK's with neighboring wireless nodes 110-n, 115-n.

Maintaining multiple GTKs at a particular node, such as the wireless node 110-2 can be problematic for several reasons. First, many network node hardware implementations do not support multiple GTKs. Thus exchanging multiple GTKs may not be compatible with existing hardware that is deployed in a network such as the wireless mesh communication network 100. Second, broadcasting of route request (RREQ) messages may require every wireless node in a mesh network to share its GTK with every neighboring node 110-n, 115-n. In large wireless mesh communication networks that can create a significant overhead processing burden.

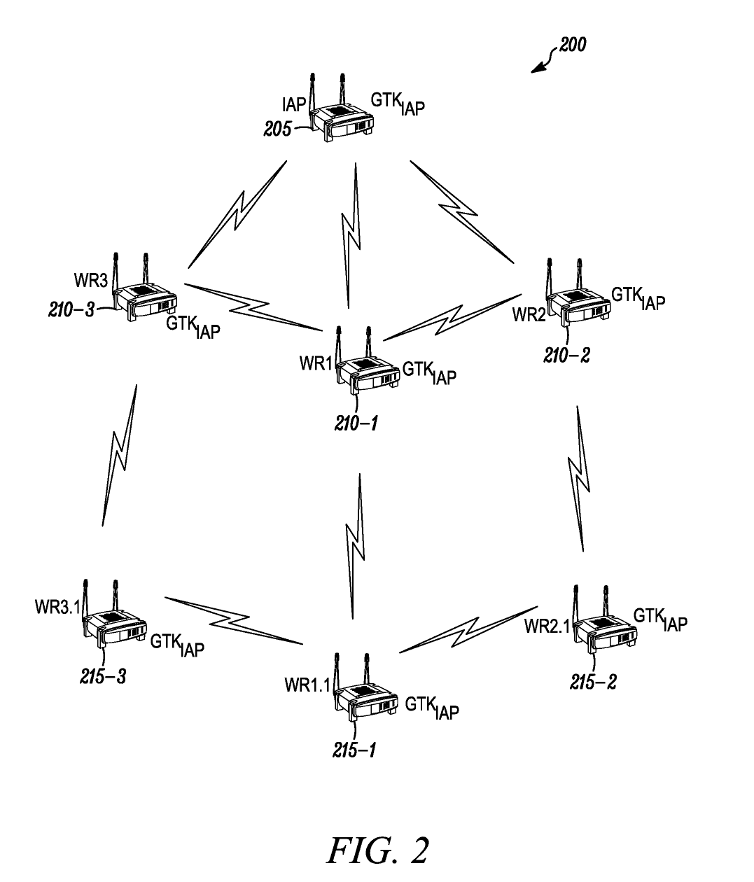

Referring to FIG. 2, a schematic diagram illustrates a use of a single GTK in a wireless mesh communication network 200, according to some embodiments of the present invention. The wireless mesh communication network 200 includes an IAP 205 that is in direct wireless communication with a first set of wireless nodes 210-n (i.e., wireless nodes 210-1, 210-2, and 210-3). The first set of wireless nodes 210-n are then in direct wireless communication with a second set of wireless nodes 215-n (i.e., wireless nodes 215-1, 215-2, and 215-3). As shown, the wireless mesh communication network 200 is treated as a single logical access point (AP) in which a single GTK is shared throughout. The GTK thus can be unique to a single common root node such as the IAP 205. The IAP 205 functions as a groupcast root node and can derive the GTK according to the IEEE 802.11i standard. The IAP 205 then propagates the GTK to the first set of wireless nodes 210-n. The first set of wireless nodes 210-n then adopt the GTK as their own GTK, and subsequently propagate the GTK to the second set of wireless nodes 215-n.

According to some embodiments of the present invention, each node in a wireless mesh communication network includes hardware that supports a limited number of GTKs specified by a key identification (ID). The key ID of a GTK used to protect a data frame can be provided in the frame itself, as described in the IEEE 802.11i standard.

Each groupcast root node, such as the IAP 205 in the wireless mesh communication network 200, first computes a current GTK and installs it for both transmission and reception. The groupcast root node also initializes a current key ID. Each groupcast frame transmitted from the groupcast root node is then tagged with the current key ID and protected with the current GTK. When a non-root downstream supplicant node, such as the wireless node 210-2, authenticates with an upstream authenticator node, such as the IAP 205, the authenticator node sends its current GTK and key ID to the supplicant node during a handshake phase. Such a handshake phase may involve, for example, a four-way handshake using a pairwise master key (PMK) and a pairwise transient key (PTK), as is known by those having ordinary skill in the art. The supplicant node then stores the GTK and the key ID. If the supplicant node subsequently selects the authenticator node as the supplicant node's groupcast uplink, the supplicant node can adopt the authenticator nodes' GTK and key ID as its own.

According to some embodiments of the present invention, a GTK thus enables groupcast data to be flooded from a root node through a wireless mesh communication network. As is known by those having ordinary skill in the art, flooding is a process whereby neighbors of a root node propagate group traffic to their downstream neighbors, and those neighbors in turn propagate the traffic to their neighbors. Flooding can increase reliability of groupcast transmissions, because a single node may receive a groupcast transmission from multiple neighbors.

A root node may periodically “roll” (i.e., replace) its GTK so as to limit the temporal scope of a GTK. When that happens, an associated key ID is also rolled. A validity of a GTK may thus expire after a predetermined time period. Also, a non-root node may change its GTK when the non-root node adopts a different groupcast uplink. When such a change occurs, a new GTK can be propagated to downstream nodes (i.e., nodes further away from a root node) in a manner that maintains groupcast connectivity between nodes. When adopting a new GTK, a node first installs the new GTK and new key ID for data reception only, and does not change its GTK for transmission. The node then processes a list of authenticated links in the network. For each link on the list, the node determines whether its GTK had previously been provided to the relevant remote node. If so, a GTK update handshake is initiated between the two nodes. As is known by those having ordinary skill in the art, such a handshake is typical for group key rolling according to the IEEE 802.11i standard. Authentication handshake data received from an authenticator node can be used to derive a pairwise transient key (PTK). Only after all of the remote nodes have either completed the handshake or timed out is the new GTK used for transmission.

When a non-root roaming node chooses a new groupcast root node, a new uplink key ID may be identical to a previous uplink key ID. In such a case, there is no need for the roaming node to delay, as described above, installation of the GTK for transmission. Thus when a supplicant node roams to a new root-node domain, the supplicant node may determine that a group transient key identifier of a new root node has not expired and is cached in a memory of the supplicant node. Therefore the supplicant node immediately installs a group transient key associated with the group transient key identifier.

Due to physical limitations of available storage for key IDs, a decryption function at a roaming node may fail to decrypt packets when a GTK is installed from a local cache at the roaming node, and not from a fresh handshake. That is because different root-nodes may use a same key ID reference, and the roaming node may not immediately distinguish between previously and newly acquired key IDs. The roaming node may thus associate decryption failure events with this potential conflict, and will trigger a two-way handshake to acquire a new GTK. As will be understood by those having ordinary skill in the art, this relationship between decryption-failures and recovery is very similar to other mechanisms that are mandatory in the IEEE 802.11i standard.

According to some embodiments of the present invention, when a supplicant node and an authenticator node complete a mutual authentication process, a GTK may be distributed from the authenticator node to the supplicant node in only one direction. After such mutual authentication, the nodes are considered equivalent peers from a security perspective, and can encrypt, decrypt, authenticate and validate groupcast data using the GTK. However, due to changes in a mesh network, the former supplicant node may become the groupcast uplink for the former authenticator node. If that occurs, the former authenticator node can request that the former supplicant node complete another mutual authentication process. This situation is described in further detail below.

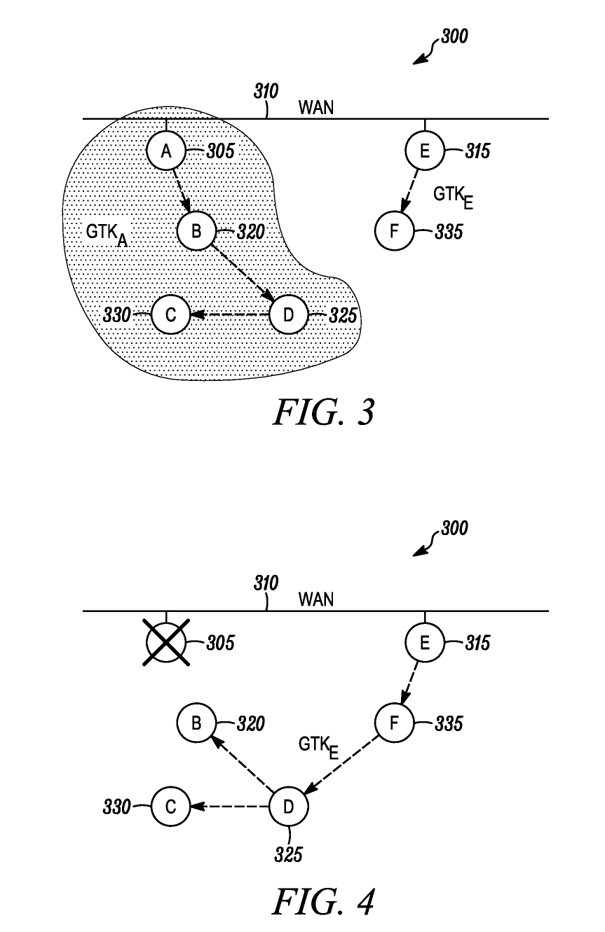

Referring to FIG. 3, a schematic diagram illustrates a use of two GTKs in a wireless mesh communication network 300, according to some embodiments of the present invention. The wireless mesh communication network 300 comprises a first root node A 305 that is operatively connected to a wide area network (WAN) 310, and a second root node E 315 that is also operatively connected to the WAN 310. The first root node A 305 generates a GTK_{A}. During an authentication process, the first root node A 305 then authenticates a node B 320 including forwarding the GTK_{A} to the node B 320. The node B 320 then authenticates a node D 325 and also forwards the GTK_{A} to the node D 325. The node D 325 then authenticates a node C 330 and forwards the GTK_{A} to the node C 330. If groupcast data are then received through the WAN 310 at the first root node A 305, the groupcast data are then transmitted from the first root node A 305 to the node B 320, from the node B 320 to the node D 325, and finally from the node D 325 to the node C 330. Each of the nodes 320, 325, 330 can encrypt, decrypt, authenticate and validate the groupcast data using the GTK_{A}.

Similarly, the second root node E 315 generates a GTK_{E} and then completes an authentication with a node F 335, including forwarding the GTK_{E} to the node F 335. The node F 335 uses the GTK_{E} because a next-hop uplink of the node F 335 is the node E 315. The wireless mesh communication network 300 is thus a mixed network comprising a plurality of different GTKs.

A benefit of some embodiments of the present invention is that a “middle node” such as the node B 320 can install only one GTK (i.e., the GTK_{A}) and use that GTK for transmission and reception of all groupcast data. Another benefit is that wireless mesh communication networks are made more robust and reliable because nodes can potentially receive groupcast data from multiple sources. For example, if radio conditions improved in the wireless mesh communication network 300, and the node C 330 could begin receiving transmissions from the node B 320, the node C 330 could immediately authenticate and validate groupcast data received from the node B 320. That is because both the node B 320 and the node D 325 use the same GTK_{A}.

Referring to FIG. 4, a schematic diagram illustrates a modification of the wireless mesh communication network 300 that occurs subsequent to the arrangement illustrated in FIG. 3, according to some embodiments of the present invention. Consider that the node A 305 becomes unavailable (e.g., it is switched off or otherwise become inoperative). If the node D 325 is within radio frequency (RF) range of the node F 335, the node D 325 may complete an authentication process with the node F 335 and then use the node F 335 as an uplink to the WAN 310. The node D 325 therefore needs to first install a new GTK (GTK_{E}) and associated key ID received from the node F 335 for reception of groupcast data. The node D 325 does not yet change its group transient key (GTK_{A}) and associated key ID. The node D 325 then processes its list of authenticated downlink neighbors. For each link in the list, if the node D 325 had previously provided its group transient key to the downlink node in the past, it is obligated to update that key. To do so, it initiates a group key update handshake. This handshake is typical for IEEE 802.11i group key rolling, as is known by those having ordinary skill in the art. Only once all of the remote nodes, including the node B 320 and the node C 330, have completed the handshake or timed out, does the node D 325 install the GTK_{E} as the current key for transmission. Note that in this situation the node B 320, which was a former authenticator node of the node D 325, has now become a supplicant node of the node D 325, and the node D 325 becomes an authenticator node of the node B 320. Thus a former supplicant node can become a groupcast uplink node of a former authenticator node. However, before the supplicant node becomes a groupcast uplink node of the authenticator node, the authenticator node requests a second authentication handshake between the authenticator node and the supplicant node.

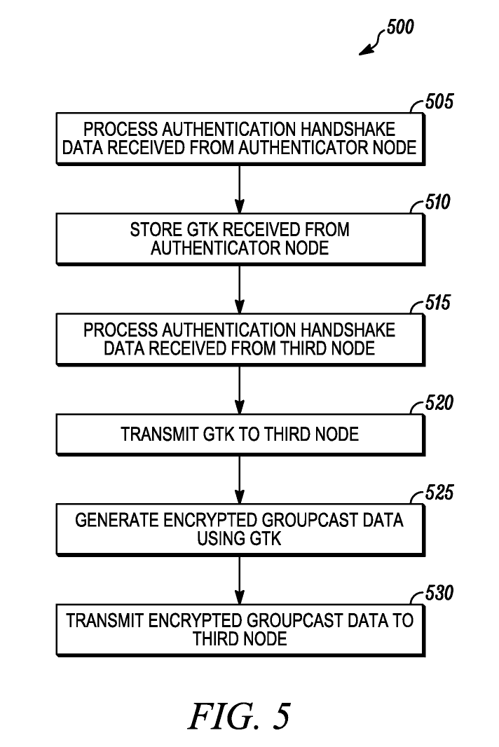

Referring to FIG. 5, a general flow diagram illustrates a method 500 for transmitting groupcast data in a wireless mesh communication network, according to some embodiments of the present invention. At step 505, a supplicant node processes authentication handshake data received from an authenticator node, where the supplicant node is a next-hop neighbor of the authenticator node away from a root node. For example, as described above in reference to FIG. 3, the node D 325 processes authentication handshake data received from the node B 320, where the node D 325 is a supplicant node and is a next-hop neighbor of the node B 320 away from the first root node A 305.

At step 510, the supplicant node stores a group transient key received from the authenticator node. The group transient key can be stored at the supplicant node for use in both transmission and reception of groupcast data. For example, under the network configuration of FIG. 3, the node D 325 stores the GTK_{A} after receiving it from the node B 320. The node D 325 can then use the GTK_{A} for both transmission and reception of groupcast data received through the first root node A 305 from the WAN 310.

The group transient key can be computed by the root node. For example, the GTK_{A} can be computed by the first root node A 305. Also, the supplicant node can select the authenticator node as a groupcast uplink node of the supplicant node.

At step 515, the supplicant node processes authentication handshake data received from a third node, wherein the third node is a next-hop neighbor of the supplicant node away from the root node. For example, under the network configuration of FIG. 3, the node D 325 processes authentication handshake data received from the node C 330, where the node C 330 is a next-hop neighbor of the node D 325 away from the first root node A 305.

At step 520, the supplicant node transmits the group transient key to the third node in response to processing the authentication handshake data received from the third node. For example, under the network configuration of FIG. 3, the node D 325 transmits the GTK_{A} to the node C 330 in response to processing the authentication handshake data received from the node C 330. Transmitting the group transient key from the supplicant node to the third node may be performed using a key encryption key (KEK) (which is typical for IEEE 802.11i group key rolling, as is known by those having ordinary skill in the art), so that non-authenticated neighboring nodes cannot obtain the group transient key.

At step 525, encrypted groupcast data are generated at the supplicant node by using the group transient key to encrypt groupcast data received from the authenticator node. For example, under the network configuration of FIG. 3, the node D 325 can generate encrypted groupcast data by using the GTK_{A} to re-encrypt groupcast data that were previously received from the node B 320 and decrypted using the GTK_{A}.

Finally, at step 530, the encrypted groupcast data are transmitted from the supplicant node to the third node. For example, under the network configuration of FIG. 3, the node D 325 can transmit the encrypted groupcast data to the node C 330.

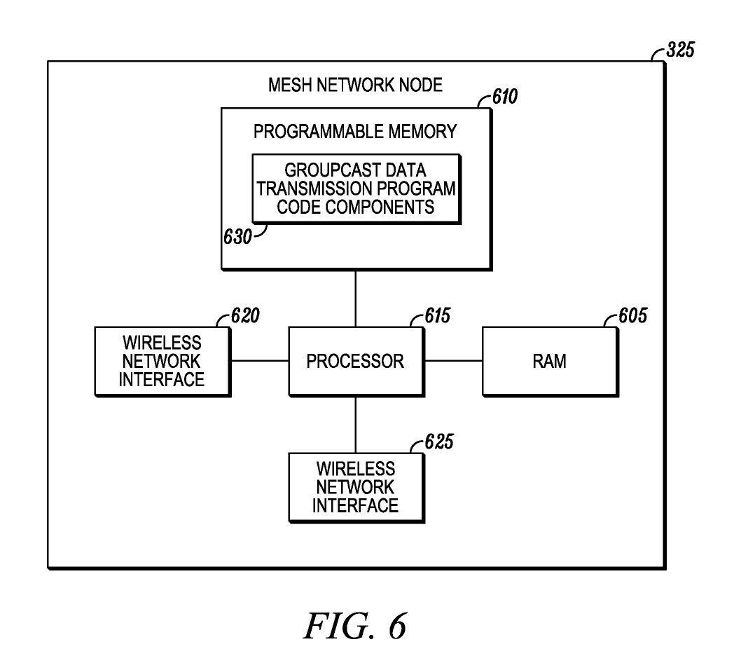

Referring to FIG. 6, a block diagram illustrates system components of the node D 325 of the wireless mesh communication network 300, according to some embodiments of the present invention. The node D 325, representing one example of a node in a wireless mesh communication network according to some embodiments of the present invention, comprises a random access memory (RAM) 605 and a programmable memory 610 that are coupled to a processor 615. The processor 615 also has ports for coupling to network interfaces 620, 625, which may comprise wired or wireless interfaces.

The network interfaces 620, 625 can be used to enable the node D 325 to communicate with neighboring nodes in the wireless mesh communication network 300. For example, the network interface 620 can be used to receive and send data packets from and to the node B 320, the node C 330 and the node F 335.

The programmable memory 610 can store operating code (OC) for the processor 615 and code for performing functions associated with the node D 325. For example, the programmable memory 610 can comprise computer readable program code components 635 for execution of a method for transmitting groupcast data in a wireless mesh communication network as described herein.

Advantages of some embodiments of the present invention thus include enabling an effective synchronization of groupcast keys at all network nodes that use a same groupcast root node. That enables group traffic to flow between network nodes with a single key, thereby eliminating packet duplication, multiple keys, and complex key management. Also, group traffic can be allowed to flow between network nodes where a secure link had not previously been established between the nodes. The method further provides groupcast path redundancy, which improves a reliability of group traffic and thus improves overall network quality of service (QoS).

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as critical, required, or essential features or elements of any or all the claims. The invention is defined solely by the appended claims including any amendments made during the pendency of this application and all equivalents of those claims as issued.

We claim:

1. A method for transmitting groupcast data in a wireless mesh communication network, the method comprising:
processing, at a supplicant node, authentication handshake data received from an authenticator node, wherein the supplicant node is a next-hop neighbor of the authenticator node away from a root node;
storing, at the supplicant node, a group transient key received from the authenticator node;
processing, at the supplicant node, authentication handshake data received from a third node, wherein the third node is a next-hop neighbor of the supplicant node away from the root node;
transmitting the group transient key from the supplicant node to the third node in response to processing the authentication handshake data received from the third node;
generating encrypted groupcast data at the supplicant node by using the group transient key to encrypt groupcast data received from the authenticator node; and
transmitting the encrypted groupcast data from the supplicant node to the third node.

2. The method of claim 1, wherein the group transient key is stored at the supplicant node for use in both transmission and reception of groupcast data.

3. The method of claim 1, wherein the group transient key is stored at the third node for use in both transmission and reception of groupcast data.

4. The method of claim 1, wherein the group transient key is computed by the root node.

5. The method of claim 1, wherein the supplicant node selects the authenticator node as a groupcast uplink node of the supplicant node after storing, at the supplicant node, the group transient key received from the authenticator node.

6. The method of claim 1, wherein the group transient key is flooded from the root node through the wireless mesh communication network.

7. The method of claim 1, wherein a validity of the group transient key expires after a predetermined time period.

8. The method of claim 1, wherein, after transmitting the encrypted groupcast data, the supplicant node roams to a new root-node domain, determines that a group transient key identifier of a new root node has not expired and is cached in a memory of the supplicant node, and therefore installs a group transient key associated with the group transient key identifier.

9. The method of claim 1, wherein the group transient key is unique to a single common root node.

10. The method of claim 1, wherein transmitting the group transient key from the supplicant node to the third node uses a key encryption key (KEK).

11. The method of claim 1, wherein the groupcast data comprise broadcast or multicast data.

12. The method of claim 1, wherein, after completing the authentication handshake between the supplicant node and the authenticator node, the supplicant node becomes a groupcast uplink node of the authenticator node.

13. The method of claim 10, wherein, before the supplicant node becomes a groupcast uplink node of the authenticator node, the authenticator node requests a second authentication handshake between the authenticator node and the supplicant node.

14. A device for transmitting groupcast data in a wireless mesh communication network, comprising:
computer readable program code components for processing, at a supplicant node, authentication handshake data received from an authenticator node, wherein the supplicant node is a next-hop neighbor of the authenticator node away from a root node;
computer readable program code components for storing, at the supplicant node, a group transient key received from the authenticator node;
computer readable program code components for processing, at the supplicant node, authentication handshake data received from a third node, wherein the third node is a next-hop neighbor of the supplicant node away from the root node;
computer readable program code components for transmitting the group transient key from the supplicant node to the third node in response to processing the authentication handshake data received from the third node;
computer readable program code components for generating encrypted groupcast data at the supplicant node by using the group transient key to encrypt groupcast data received from the authenticator node; and
computer readable program code components for transmitting the encrypted groupcast data from the supplicant node to the third node.

15. The device of claim 14, wherein the group transient key is stored at the supplicant node for use in both transmission and reception of groupcast data.

16. The device of claim 14, wherein the group transient key is stored at the third node for use in both transmission and reception of groupcast data.

17. The device of claim 14, wherein the group transient key is computed by the root node.

18. The device of claim 14, wherein the supplicant node selects the authenticator node as a groupcast uplink node of the supplicant node after storing, at the supplicant node, the group transient key received from the authenticator node.

19. The device of claim 14, wherein the group transient key is flooded from the root node through the wireless mesh communication network.

20. The device of claim 14, wherein a validity of the group transient key expires after a predetermined time period.
